(19) United States
(12) Patent Application Publication
(10) Pub. No.: US 2022/0035944 A1
(43) Pub. Date: Feb. 3, 2022

(54) IDENTIFIER SWITCHING DEVICE, COMPUTER READABLE MEDIUM, AND IDENTIFIER SWITCHING METHOD

(71) Applicant: Mitsubishi Electric Corporation, Tokyo (JP)

(72) Inventors: Takashi ITO, Tokyo (JP); Fumio OMATSU, Tokyo (JP)

(73) Assignee: Mitsubishi Electric Corporation, Tokyo (JP)

(21) Appl. No.: 17/499,525

(22) Filed: Oct. 12, 2021

Related U.S. Application Data
(63) Continuation of application No. PCT/JP2019/022731, filed on Jun. 7, 2019.

(51) Int. Cl. G06F 21/62

(52) U.S. Cl. CPC G06F 21/6245

(57) ABSTRACT

An ID switching device (10) includes an ID request unit (16) and an ID determination unit (17). The ID request unit (16) outputs an ID request (16a) that requests switching to a new ID. The ID determination unit (17) refers to rule information (12a) and history information (15a) when the ID request (16a) is outputted, and determines an ID that agrees with the rule information (12a), as the new ID. The rule information (12a) is information for determining the new ID. In the rule information (12a), a history condition that is a use history of the new ID is defined as a condition for determining the new ID. The history information (15a) is information having a plurality of history records in each of which an ID and a use history of the ID are associated.

### CROSS REFERENCE TO RELATED APPLICATION

This application is a Continuation of PCT International Application No. PCT/JP2019/022731, filed on Jun. 7, 2019, which is hereby expressly incorporated by reference into the present application.

### TECHNICAL FIELD

The present invention relates to a device, program, and method for switching an identifier.

### BACKGROUND ART

Prior art includes a technique of switching an identifier in order to improve privacy protection (for example, Patent Literature 1).

### CITATION LIST

### Patent Literature

Patent Literature 1: International Publication No. WO 2008/126180 A1

When switching an identifier, a method in which a number of identifiers is limited is desirable because it allows easy identifier management. With the method in which the number of identifiers is limited, a situation where an identifier used in the past is used again occurs. When such a situation occurs, a third party may get to know user's behavior, which reduces privacy protection. Therefore, when switching an identifier to a new identifier, what kind of identifier to switch to is important.

However, Patent Literature 1 only discloses a method of switching an identifier presently in use to another identification information, and does not disclose what kind of identifier to switch to. In particular, there is no disclosure of how an identifier should be reused when the number of identifiers is limited.

### SUMMARY OF INVENTION

### Technical Problem

An objective of the present invention is to provide an identifier switching device which, when switching an identifier to a new identifier, can realize both improvement of user privacy protection and reduction of a management load over a plurality of identifiers by considering what identifier to switch to.

### Solution to Problem

An identifier switching device of the present invention includes:

a switching request unit to output a switching request that requests switching to a new identification; and

a determination unit to refer to rule information in a rule information storage device which stores the rule information and history information in a history storage device which stores the history information, when the switching request is outputted, the rule information being information for determining the new identifier and in which a history condition that is a use history of the new identifier is defined as a condition for determining the new identifier, the history information having a plurality of history records in each of which an identifier and a use history of the identifier are associated; and to determine, from among the plurality of history records, an identifier that agrees with the rule information, as the new identifier.

### Advantageous Effects of Invention

According to the present invention, an identifier switching device can be provided which, when switching an identifier to a new identifier, can realize both privacy protection required by a user and reduction of a management load over a plurality of identifiers.

### BRIEF DESCRIPTION OF DRAWINGS

FIG. 1 is a diagram of Embodiment 1 illustrating transmission of a V2X message.

FIG. 2 is a diagram of Embodiment 1 illustrating a situation where a vehicle 80 moves from home to a workplace.

FIG. 3 is a diagram of Embodiment 1 illustrating a situation where different certificate IDs are used for movement from home to the workplace.

FIG. 4 is a diagram of Embodiment 1 which is a function block diagram of an ID switching device 10.

FIG. 5 is a diagram of Embodiment 1 illustrating a hardware configuration of the ID switching device 10.

FIG. 6 is a diagram of Embodiment 1 which is a sequence diagram illustrating operations of the ID switching device 10.

FIG. 7 is a diagram of Embodiment 1 illustrating rule information 12a.

FIG. 8 is a diagram of Embodiment 1 illustrating history information 15a.

FIG. 9 is a diagram of Embodiment 1 illustrating a functional configuration of an ID switching device 10A.

FIG. 10 is a diagram of Embodiment 1 illustrating an example in which the ID switching device 10 is applied to a payment system that accepts electronic money.

FIG. 11 is a diagram of Embodiment 1 illustrating a configuration in which functions of the ID switching device 10 are implemented by hardware.

### DESCRIPTION OF EMBODIMENTS

An embodiment of the present invention will be described below with referring to drawings. In the drawings, the same or equivalent portions are denoted by the same reference numeral. When describing the embodiment, the same or equivalent portions will not be described, or will be described only briefly, as necessary.

### Embodiment 1

(1) In the following, an identifier switching device 10 will be expressed as an ID switching device 10.
(2) In the following, a representation “ID” signifies an identifier.

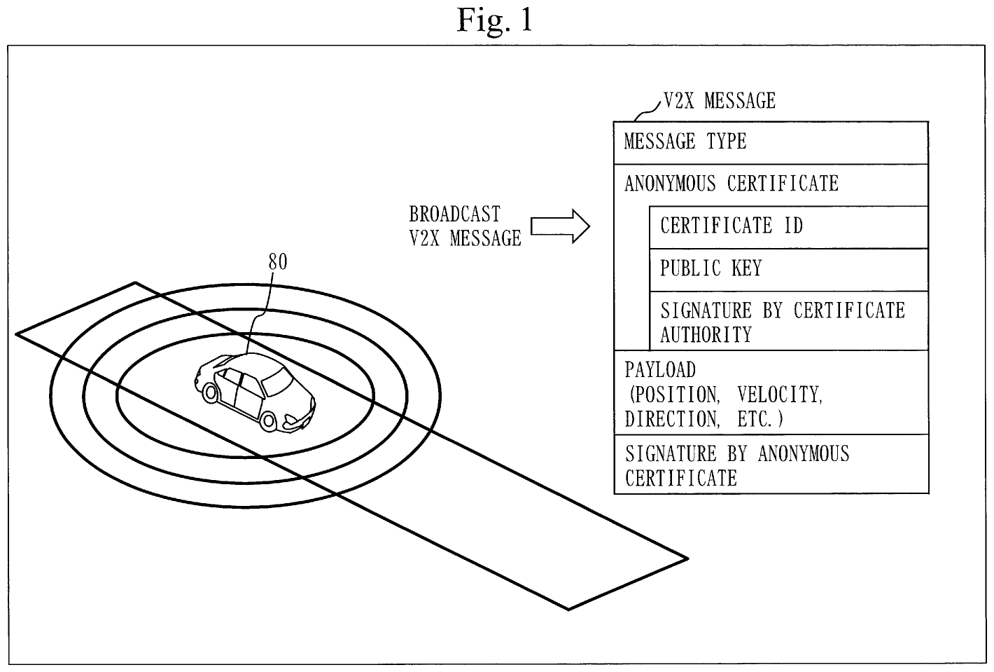

The ID switching device 10 according to Embodiment 1 will now be described with referring to FIGS. 1 to 11. In the following description, it is assumed that an ID to switch to by the ID switching device 10 is used by a Vehicle-to-X (V2X) system.

FIG. 1 illustrates transmission of a V2X message. In the V2X system, a vehicle 80 transmits a signed V2X message by broadcast. The V2X message uses a signature by means of an anonymous certificate for privacy protection of a vehicle owner. The anonymous certificate includes a certificate ID, a public key, and a signature by a certificate authority. The certificate ID is an ID for switching by the ID switching device 10.

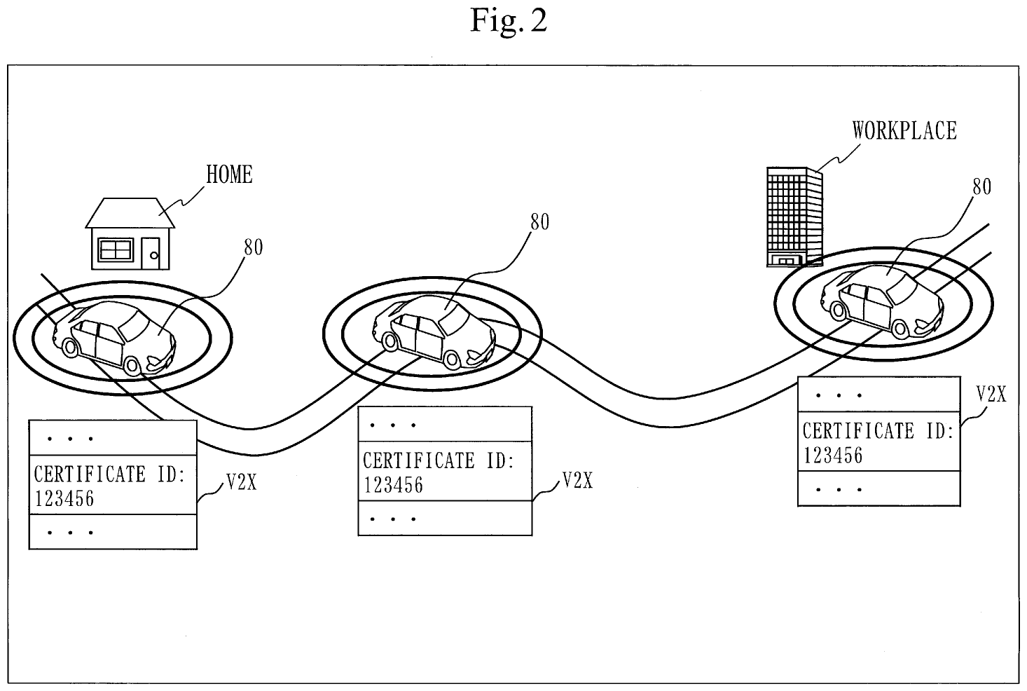

FIG. 2 illustrates a situation where the vehicle 80 moves from home to a workplace. In FIG. 2, “certificate ID=123456” is used for movement from home to the workplace. If a single anonymous certificate such as “certificate ID=123456” is used continuously, an attacker having received the V2X message may trace moving history. In particular, if a relation between a start point and a destination is found, it may cause infringement of privacy.

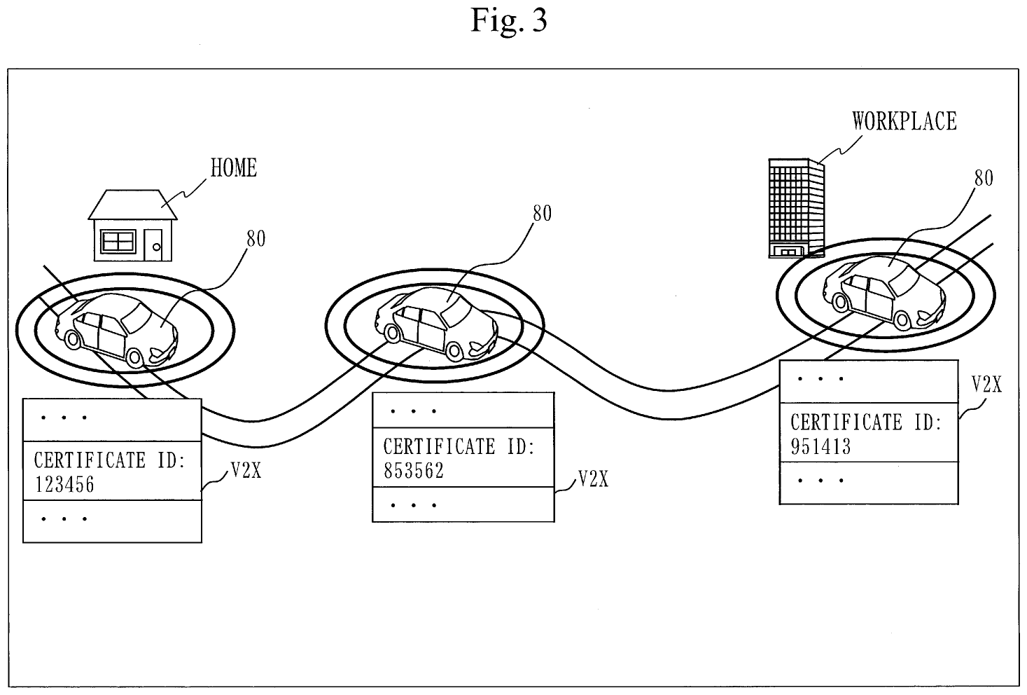

FIG. 3 illustrates a situation where different certificate IDs are used for movement from home to the workplace. At home, “certificate ID=123456” is used; between home and the workplace, “certificate ID=853562” is used; and at the workplace, “certificate ID=951413” is used. When certificate IDs that are all different from each other are employed in a traveling route of the vehicle 80 of FIG. 3, a large number of certificate IDs must be managed, and accordingly an operation load is large. The ID switching device 10 according to Embodiment 1 protects user privacy by performing ID switching on a premise that a number of IDs to be used is limited. The ID switching device 10 of Embodiment 1 allows repeated use of one ID at different times. The feature of the case of FIG. 3 is that although repeated use of the same ID is allowed at home and at an intermediate point between the home and the workplace, repeated use is controlled on the basis of rule information 12a. This feature allows an attempt to realize both reduction of an ID management load and reinforcement of user privacy protection. It is crucial that “privacy protection required by the user” be realized flexibly because a notion about privacy, that is, what constitutes infringement of privacy, differs depending on the user. The ID switching device 10 according to Embodiment 1 realizes this by using different rule information 12a for a different user.

### Description of Configurations

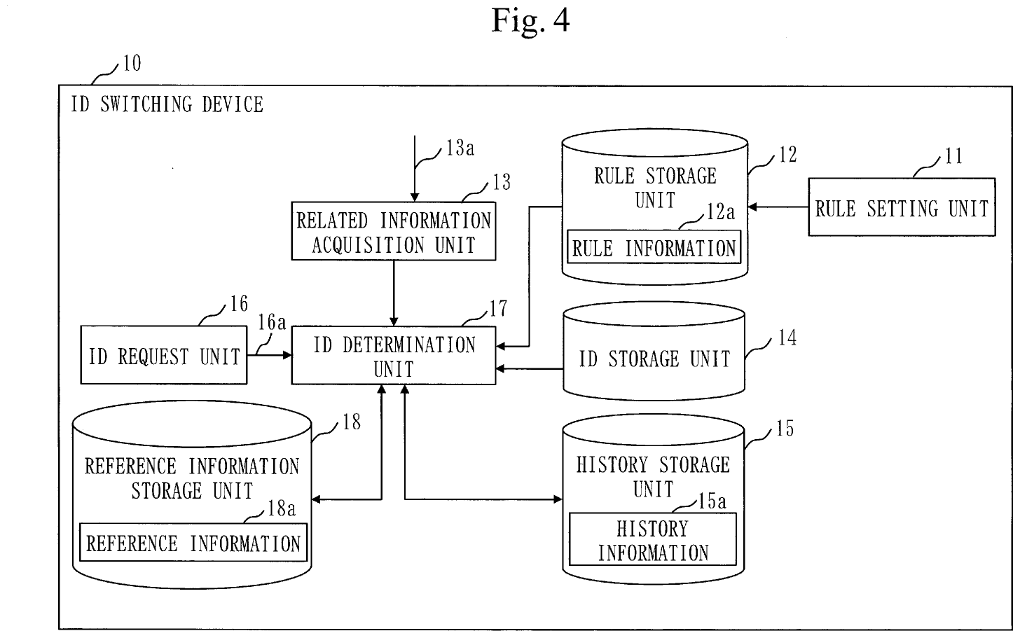

FIG. 4 illustrates function blocks of the ID switching device 10.

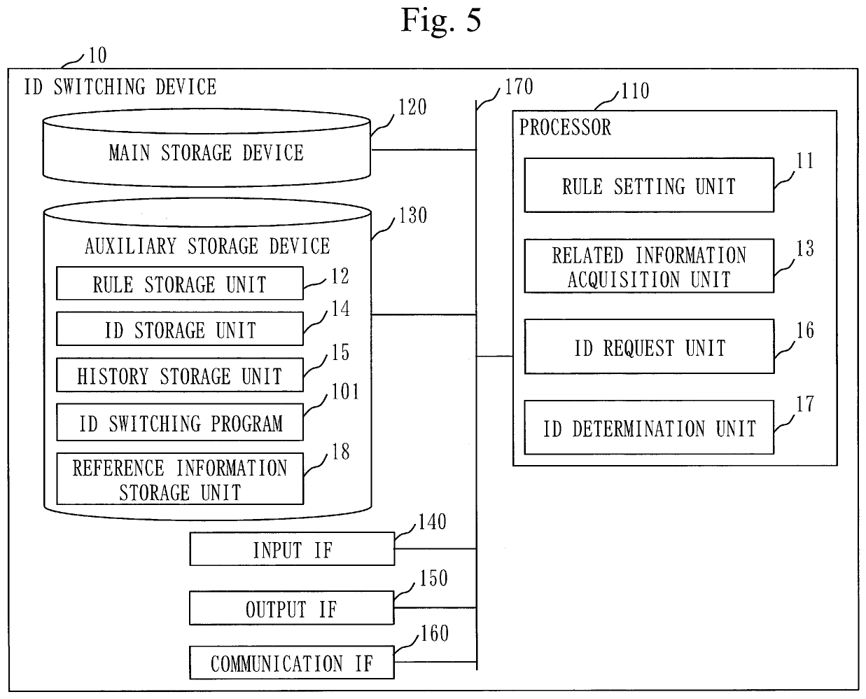

FIG. 5 illustrates a hardware configuration of the ID switching device 10. The hardware configuration of the ID switching device 10 will be described with referring to FIG. 5.

The ID switching device 10 is a computer. The ID switching device 10 is provided with a processor 110. In addition to the processor 110, the ID switching device 10 is provided with other hardware devices such as a main storage device 120, an auxiliary storage device 130, an input IF 140, an output IF 150, and a communication IF 160. The interface is expressed as IF. The processor 110 is connected to the other hardware devices via a signal line 170 and controls the other hardware devices.

The ID switching device 10 is provided with a rule setting unit 11, a related information acquisition unit 13, an ID request unit 16, and an ID determination unit 17, as function elements. Functions of the rule setting unit 11, related information acquisition unit 13, ID request unit 16, and ID determination unit 17 are implemented by an ID switching program 101. The ID switching program 101 is stored in the auxiliary storage device 130.

The processor 110 is a device that runs the ID switching program 101. The ID switching program 101 is a program that implements the functions of the rule setting unit 11, related information acquisition unit 13, ID request unit 16, and ID determination unit 17. The processor 110 is an Integrated Circuit (IC) which performs computation processing. Specific examples of the processor 110 are a Central Processing Unit (CPU), a Digital Signal Processor (DSP), and a Graphics Processing Unit (GPU).

The main storage device 120 is a storage device. Specific examples of the main storage device 120 are a Static Random-Access Memory (SRAM) and a Dynamic Random-Access Memory (DRAM). The main storage device 120 holds a computation result of the processor 110.

The auxiliary storage device 130 is a storage device that keeps data in a non-volatile manner. A specific example of the auxiliary storage device 130 is a Hard Disk Drive (HDD). The auxiliary storage device 130 may be a portable recording medium such as a Secure Digital (SD, registered trademark) memory card, a NAND flash, a flexible disk, an optical disk, a compact disk, a Blu-ray (registered trademark) Disc, and a Digital Versatile Disk (DVD). The auxiliary storage device 130 serves as a rule storage unit 12, an ID storage unit 14, a history storage unit 15, and a reference information storage unit 18.

The input IF 140 is a port to which data is inputted from devices. The output IF 150 is a port to which various types of apparatuses are connected and through which data is outputted to the various types of apparatuses by the processor 110. The communication IF 160 is a communication port through which the processor communicates with the other devices.

The processor 110 loads the ID switching program 101 to the main storage device 120 from the auxiliary storage device 130, reads the ID switching program 101 from the main storage device 120, and runs the ID switching program 101. Not only the ID switching program 101 but also an Operating System (OS) is stored in the main storage device 120. The processor 110 runs the ID switching program 101 while running the OS. The ID switching device 10 may be provided with a plurality of processors that substitute for the processor 110. The plurality of processors share running of the ID switching program 101. Each processor is a device that runs the ID switching program 101, just as the processor 110 does. Data, information, signal values, and variable values which are utilized, processed, or outputted by the ID switching program 101 are stored in the main storage device 120, the auxiliary storage device 130, or a register or cache memory in the processor 110.

The ID switching program 101 is a program that causes the computer to execute processes, procedures, or stages corresponding to the rule setting unit 11, the related information acquisition unit 13, the ID request unit 16, and the ID determination unit 17 each with its “unit” being replaced by “process”, “procedure”, or “stage”.

An ID switching method is a method that is carried out by the ID switching device 10, which is the computer, running the ID switching program 101. The ID switching program 101 may be provided as being stored in a computer-readable recording medium, or may be provided as a program product.

### Description of Operations

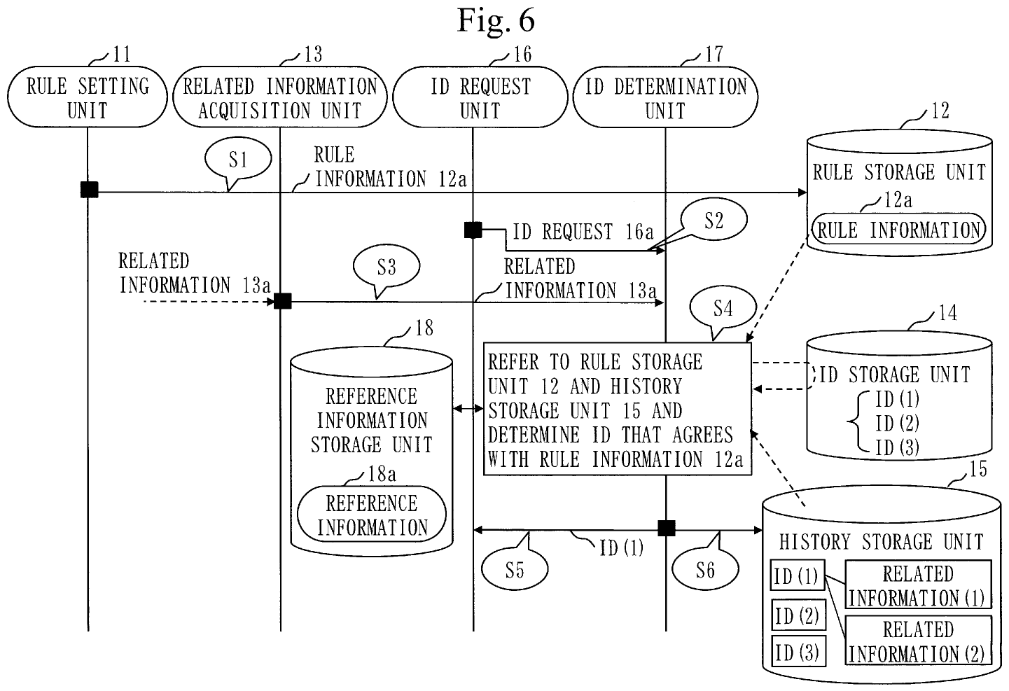

FIG. 6 presents a sequence illustrating operations of the ID switching device 10. The operations of the ID switching device 10 will be described with referring to FIG. 6. An operation procedure of the ID switching device 10 corresponds to the ID switching method. A program that implements the operations of the ID switching device 10 corresponds to the ID switching program 101.

### Step S1

For preparation, the rule setting unit 11 sets the rule information 12a which implements privacy protection required by the user, and stores the preset rule information 12a to the auxiliary storage device 130 which is a rule information storage device.

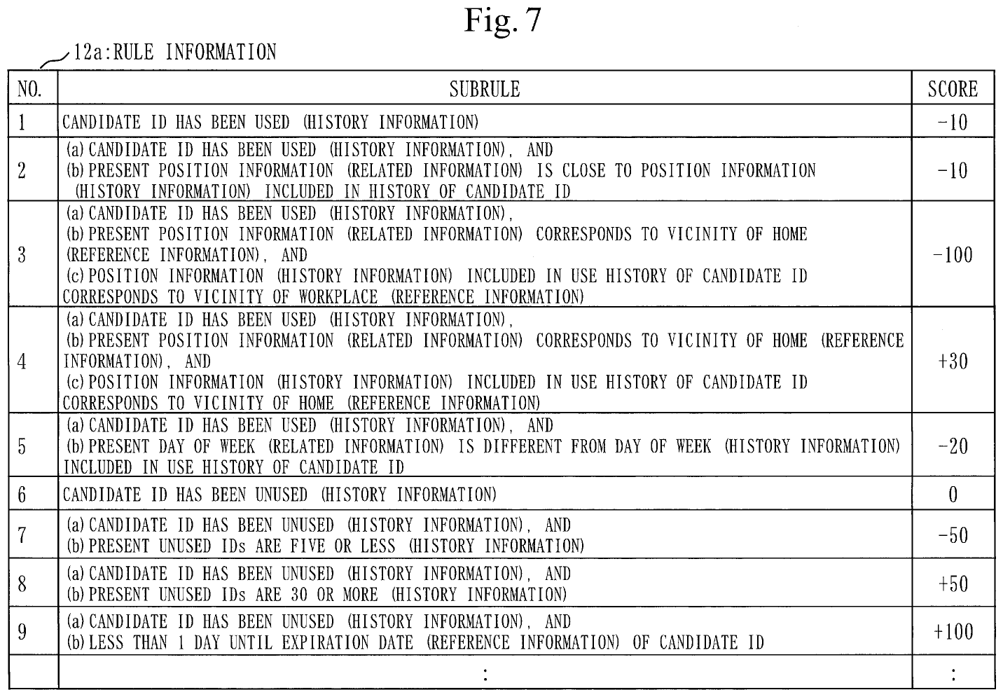

FIG. 7 illustrates the rule information 12a. The rule information 12a will be described later.

### Step S2

The ID request unit 16 outputs an ID request 16a which is a switching request that requests switching to a new ID. The ID request unit 16 is a switching request unit.

Specifically, the ID request unit 16 transmits the ID request 16a requesting an ID, to the ID determination unit 17. An ID in the V2X system is a certificate ID of an anonymous certificate.

### Step S3

The related information acquisition unit 13 acquires related information 13a from another application program (not illustrated). In the V2X system, the related information acquisition unit 13 acquires the related information 13a from an in-vehicle apparatus. The related information acquisition unit 13 transmits the acquired related information 13a to the ID determination unit 17. The related information 13a is history reserve information that can be associated as a use history, with a new ID. In the V2X system, the related information 13a is information such as date, day of the week, time, and position information.

### Step S4

In step S4, when an ID request 16a is outputted, the ID determination unit 17 refers to the rule information 12a in the rule information storage device which stores the rule information 12a and the history information 15a in a history storage device which stores the history information 15a, and determines, from among a plurality of IDs stored in the ID storage unit 14, an ID that agrees with the rule information 12a, as a new ID. As will be described later, the plurality of IDs stored in the ID storage unit 14 are stored in the history storage unit 15 as well. Hence, to determine a new ID out of the ID storage unit 14 is the same as to determine a new ID from among a plurality of history records in the history storage unit 15. The rule storage unit 12 corresponds to the rule information storage device, as illustrated in FIG. 5. The rule information storage device is implemented by the auxiliary storage device 130. The history storage unit 15 corresponds to a history storage device, as illustrated in FIG. 5. The history storage device is implemented by the auxiliary storage device 130. The ID determination unit 17 determines the new ID by referring also to the related information 13a which is the history reserve information. When referring to the rule information 12a, the ID determination unit 17 collates an ID with each subrule of a plurality of subrules.

In the following, step S4 will be described specifically.

The ID determination unit 17 refers to the rule information 12a in the rule storage unit 12, the history information 15a in the history storage unit 15, reference information 18a in the reference information storage unit 18, and the related information 13a, and determines, from among the plurality of IDs stored in the ID storage unit 14, an ID that agrees with the rule information 12a the most.

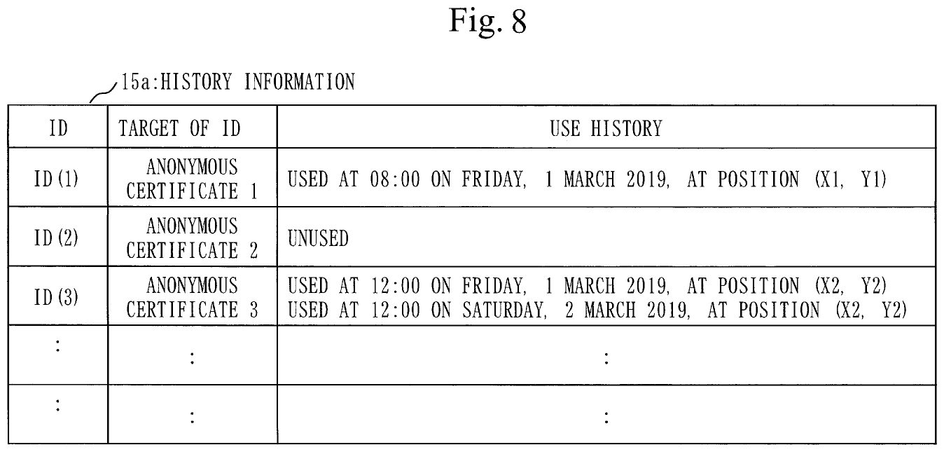

The ID determination unit 17 selects a plurality of candidate IDs out of the ID storage unit 14. Selection may be made from all IDs in the ID storage unit 14 or from some IDs in the ID storage unit 14. The IDs stored in the ID storage unit 14 are stored as history records of the history storage unit 15. If an ID is unused, it is stored as having a use history of being unused, as illustrated in FIG. 8 to be described later. The ID determination unit 17 collates a candidate ID with the subrule described in the rule information 12a, and calculates a score of the candidate ID. A total score of results of collation with all subrules is the score of the candidate ID. Finally, the ID determination unit 17 determines a candidate ID with the highest score, as an ID that should be employed.

FIG. 8 illustrates the history information 15a. The history information 15a will be described with referring to FIG. 8. The history information 15a has a plurality of history records in each of which an ID and a use history of the ID are associated with each other. In FIG. 8, an anonymous certificate corresponding to the ID is also included in the history record. Each row of ID(1), ID(2), and ID(3) constitutes a history record. In the history information 15a, the use history of each of ID(1) to ID(3) shows date, day of the week, time, and position information. The use history is a history of how the ID was used in the V2X system.

### Rule Information 12a

The rule information 12a will be described with referring to FIG. 7. The rule information 12a is information for determining a new ID and in which a history condition that is a use history required of a new ID is defined. The rule information 12a is stored in the auxiliary storage device 130 being the rule information storage device. A representation that reads history information, related information, or reference information in parentheses as a subrule of each row of the rule information 12a illustrated in FIG. 7 signifies that judgment is possible using the history information, related information, or reference information. Note that a description with parenthesized history information indicates a history condition. The rule information 12a has a plurality of subrules. Each subrule is associated with a score.

### Subrule

FIG. 7 specifically illustrates nine subrules of NO. 1 to NO. 9.

Subrule 1 defines that the candidate ID has been used. “Candidate ID has been used” is a history condition. The ID determination unit 17 can judge from the history information 15a whether the candidate ID agrees with a history condition or not. If the candidate ID agrees with subrule 1, that is, if the use history corresponding to the candidate ID is not “unused”, the ID determination unit 17 gives a score “−10” to the candidate ID.

Subrule 2 defines the following (a) and (b).

(a) The candidate ID has been used.

(b) “Present position information” included in the related information 13a is close to position information included in the use history of the candidate ID.

Item (a) is the same as item (a) of subrule 1 and accordingly its description will be omitted.

Item (b) can be judged by collating the related information 13a with the history information 15a.

A judging criterion regarding whether “close” or not is set in subrule 2, although not illustrated. If the candidate ID agrees with subrule 2 (both of (a) and (b)), the ID determination unit 17 gives a score “−10” to the candidate ID.

Subrule 3 defines the following (a), (b), and (c).

(a) The candidate ID has been used.

(b) “Present position information” included in the related information 13a corresponds to vicinity of the home.

(c) Position information included in the use history of the candidate ID corresponds to vicinity of the workplace.

Item (a) is the same as item (a) of subrule 1 and accordingly its description will be omitted. Item (b) can be judged by collating the related information 13a with the reference information 18a. The reference information 18a is stored in the auxiliary storage device 130, as illustrated in FIG. 5. In this case, the reference information 18a has position information of the user's home. Also, a judging criterion regarding whether or not present position information corresponds to vicinity of home is set in subrule 3, although not illustrated. Item (c) is a history condition.

Item (c) can be judged by collating the history information 15a with the reference information 18a. In this case, the reference information 18a has position information of the user's workplace.

If the candidate ID agrees with subrule 3, the ID determination unit 17 gives a score “−100” to the candidate ID.

Subrule 4 defines the following (a), (b), and (c).

(a) The candidate ID has been used.

(b) “Present position information” included in the related information 13a corresponds to vicinity of home.

(c) Position information included in the use history of the candidate ID corresponds to vicinity of home. Items (a) and (b) are the same as items (a) and (b) of subrule 3 and accordingly their descriptions will be omitted. Item (c) can be judged by collating the history information 15a with the reference information 18a. In this case, the reference information 18a has position information of the user's home. Also, a judging criterion regarding whether or not the position information corresponds to vicinity of to the user's home is set in subrule 4, although not illustrated.

If the candidate ID agrees with subrule 4, the ID determination unit 17 gives a score “+30” to the candidate ID.

Subrule 5 defines the following (a) and (b).

(a) The candidate ID has been used.

(b) “Present day of the week” included in the related information 13a is different from the day of the week included in the use history of the candidate ID.

Item (a) is the same as items (a) of subrule 1 and accordingly its descriptions will be omitted. Item (b) can be judged by collating the related information 13a with the history information 15a.

If the candidate ID agrees with subrule 5, the ID determination unit 17 gives a score “−20” to the candidate ID.

Subrule 6 defines that the candidate ID has been unused. Whether the candidate ID has been unused or not can be judged by referring to the history information 15a.

If the candidate ID agrees with subrule 6, the ID determination unit 17 gives a score “0” to the candidate ID.

Subrule 7 defines the following (a) and (b).

(a) The candidate ID has been unused.

(b) Present unused IDs are five or less.

Item (a) is the same as subrule 6 and accordingly its description will be omitted. Item (b) can be judged by referring to the history information 15a.

If the candidate ID agrees with subrule 7, the ID determination unit 17 gives a score “−50” to the candidate ID.

Subrule 8 defines the following (a) and (b).

(a) The candidate ID has been unused.

(b) Present unused IDs are 30 or more.

Item (a) is the same as subrule 6 and accordingly its descriptions will be omitted. Item (b) can be judged by referring to the history information 15a.

If the candidate ID agrees with subrule 8, the ID determination unit 17 gives a score “+50” to the candidate ID.

Subrule 9 defines the following (a) and (b).

(a) The candidate ID has been unused.

(b) Less than 1 day is left until expiration date of the candidate ID.

Item (a) is the same as item (a) of subrule 6 and accordingly its description will be omitted. Item (b) can be judged by referring to the “date” held by the related information 13a with the reference information 18a.

In this case, the reference information 18a has expiration date of the ID.

If the candidate ID agrees with subrule 9, the ID determination unit 17 gives a score “+100” to the candidate ID.

As described above, the ID determination unit 17 judges agreement with all subrules. A total of all scores of the agreeing subrules is the score of the candidate ID.

The ID determination unit 17 determines, from among the plurality of history records, an ID that agrees with the rule information 12a the most, as the new ID. That is, the ID determination unit 17 determines, from among the plurality of candidate IDs, a candidate ID with the highest score, as the new ID.

### Step S5

The ID determination unit 17 transmits the determined ID to the ID request unit 16.

### Step S6

Also, the ID determination unit 17, when having determined the new ID, associates the related information 13a which is the history reserve information, as the history information with the new ID. The history information is a use history. The ID determination unit 17 stores the new ID with which the history information is associated, as a history record to the auxiliary storage device 130 being the history storage device. The stored history record is used for determining a next new ID.

### Description of Effect of Embodiment 1

As the ID switching device 10 switches the ID on the basis of the preset rule information 12a, an ID to switch to can be determined flexibly depending on setting of the rule information 12a.

As the ID switching device 10 switches the ID on the basis of the rule information 12a being preset by the user with using the rule setting unit 11, an ID suitable to the user can be employed. Therefore, the ID switching device 10 can perform ID switching suited to privacy protection required by the user.

### Modification 1

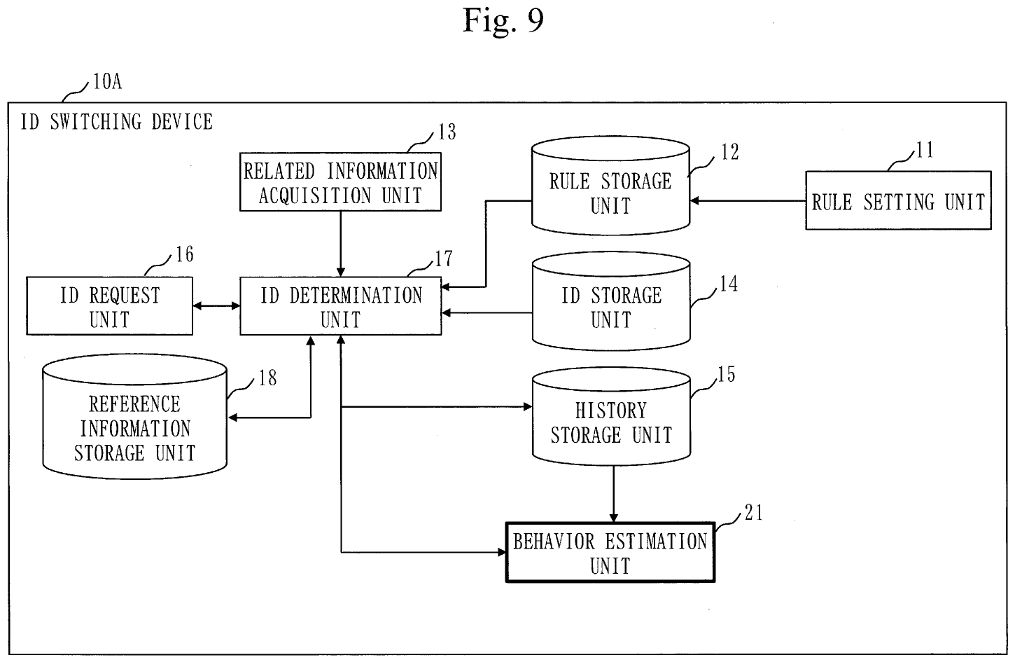

An ID switching device 10A according to a modification of the ID switching device 10 of Embodiment 1 will be described with referring to FIG. 9.

FIG. 9 illustrates a functional configuration of the ID switching device 10A. The ID switching device 10A is further provided with a behavior estimation unit 21 as a function element. The behavior estimation unit 21 is an estimation unit. Although a hardware configuration of the ID switching device 10A is not illustrated, in the hardware configuration of the ID switching device 10A, the processor 110 of the ID switching device 10 of FIG. 5 is further provided with the behavior estimation unit 21 as a function element.

The behavior estimation unit 21 estimates related information 13a which is history reserve information of a new ID. If behavior of a vehicle can be estimated, the behavior estimation unit 21 estimates the related information 13a. For example, the behavior estimation unit 21 can estimate behavior of the vehicle by acquiring, from a navigation system, a destination preset in the navigation system, or by machine learning on the basis of history information 15a. The behavior estimation unit 21 estimates the related information 13a such as “date, date of the week, time, and position information” that the vehicle would pass through, from estimated behavior of the vehicle. An ID determination unit 17 determines a new ID with using the related information 13a estimated by the behavior estimation unit 21. The behavior estimation unit 21 may estimate a plurality of pieces of related information 13a. For example, if a destination is set in the navigation system, the behavior estimation unit 21 estimates a plurality of pieces of related information 13a corresponding to a plurality of positions between the present position and the destination. The ID determination unit 17 determines a new ID for each of the plurality of pieces of the related information 13a.

With the behavior estimation unit 21, even if a related information acquisition unit 13 does not acquire related information 13a, a new ID can be determined with using the estimated related information 13a.

In the above embodiment, description is made on the basis of an assumption that the ID switching device 10 would be applied to a V2X system. However, the ID switching device 10 can be applied to any system that can use ID switching.

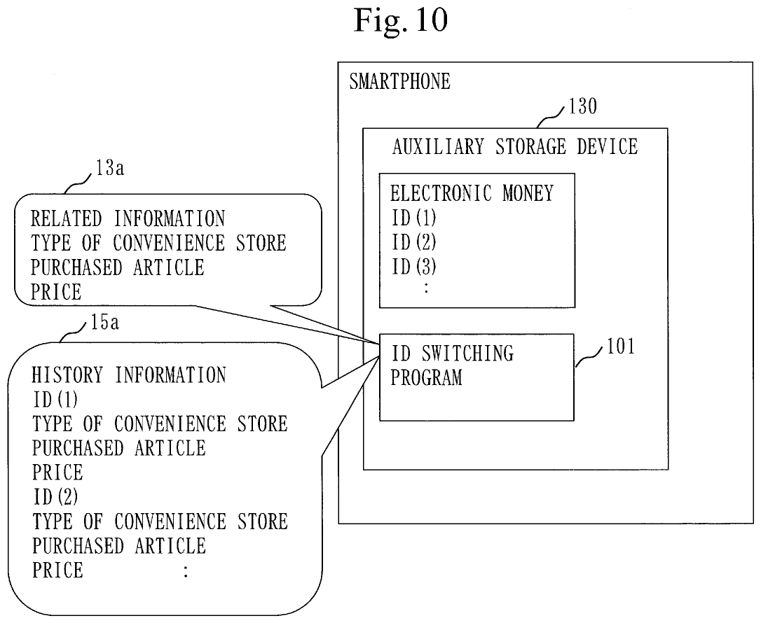

FIG. 10 illustrates a case in which the ID switching device 10 is applied to a payment system that accepts electronic money. An ID switching program 101 is installed in a smartphone as an application. The smartphone is an ID switching device 10. Each electronic money type is associated with an ID. In the payment system that accepts electronic money, the related information 13a includes a specific type of convenience store, an article the user purchased, and a price of the article. The related information 13a may further include date, day of the week, time, and position information, just as in the V2X system. In the history information 15a, the ID is associate with “specific type of convenience store, an article the user purchased, and price of the article”.

The ID switching device 10 or an ID switching program can be applied also to a payment system that accepts electronic money as illustrated in FIG. 10.

The ID switching device 10 and the ID switching program 101 can be applied to various types of systems such as a point card system that uses an unsigned point card, a payment system that accepts virtual currency, and an entry/exit management system, in addition to the V2X system, and the payment system that accepts electronic money.

### Supplemental to Hardware Configuration

In the ID switching device 10 of FIG. 5, the functions of the ID switching device 10 are implemented by software. Alternatively, the functions of the ID switching device 10 may be implemented by hardware.

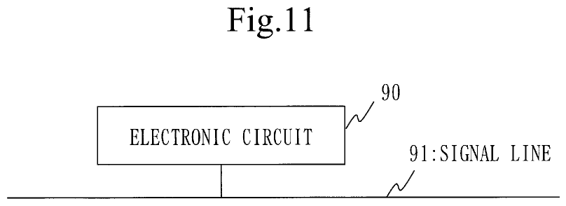

FIG. 11 illustrates a configuration in which the functions of the ID switching device 10 are implemented by hardware.

An electronic circuit 90 of FIG. 11 is a dedicated electronic circuit that implements the functions of the rule setting unit 11, related information acquisition unit 13, ID request unit 16, ID determination unit 17, rule storage unit 12, ID storage unit 14, history storage unit 15, and reference information storage unit 18, of the ID switching device 10.

The electronic circuit 90 is connected to a signal line 91. The electronic circuit 90 is specifically a single circuit, a composite circuit, a programmed processor, a parallel-programmed processor, a logic IC, a GA, an ASIC, or an FPGA. Note that GA stands for Gate Array; ASIC for Application Specific Integrated Circuit; and FPGA for Field-Programmable Gate Array. Functions of constituent elements of the ID switching device 10 may be implemented by one electronic circuit, or may be implemented by a plurality of electronic circuit through dispersion. Some of the functions of the constituent elements of the ID switching device 10 may be implemented by an electronic circuit, and the remaining functions may be implemented by software.

The processor 110 and the electronic circuit 90 are each called processing circuitry. In the ID switching device 10, the functions of the rule setting unit 11, related information acquisition unit 13, ID request unit 16, ID determination unit 17, rule storage unit 12, ID storage unit 14, history storage unit 15, and reference information storage unit 18 may be implemented by processing circuitry.

Embodiment 1 has been described above. Of Embodiment 1, one portion may be practiced. Alternatively, of Embodiment 1, two or more portions may be combined and practiced. Note that the present invention is not limited to Embodiment 1, but can be changed in various manners as necessary.

### REFERENCE SIGNS LIST

10: ID switching device; 11: rule setting unit; 12: rule storage unit; 12a: rule information; 13: related information acquisition unit; 13a: related information; 14: ID storage unit; 15: history storage unit; 15a: history information; 16: ID request unit; 16a: ID request; 17: ID determination unit; 18: reference information storage unit; 18a: reference information; 21: behavior estimation unit; 80: vehicle; 90: electronic circuit; 91: signal line; 101: ID switching program; 110: processor; 120: main storage device; 130: auxiliary storage device; 140: input IF; 150: output IF; 160: communication IF; 170: signal line.

1. An identifier switching device comprising:
processing circuitry
to output a switching request that requests switching to a new identification, and
to refer to rule information in a rule information storage device which stores the rule information and history information in a history storage device which stores the history information, when the switching request is outputted, the rule information being information for determining the new identifier and in which a history condition that is a use history of the new identifier is defined as a condition for determining the new identifier, the history information having a plurality of history records in each of which an identifier and a use history of the identifier are associated; and to determine, from among the plurality of history records, an identifier that agrees with the rule information, as the new identifier.

2. The identifier switching device according to claim 1, wherein the processing circuitry
acquires history reserve information that can be associated as a use history, with the new identifier, and
determines the new identifier by referring also to the history reserve information.

3. The identifier switching device according to claim 2, wherein the processing circuitry
estimates the history reserve information of the new identifier, and
determines the new identifier with using the estimated history reserve information.

4. The identifier switching device according to claim 2,
wherein the processing circuitry, when having determined the new identifier, associates the history reserve information, as the history information with the new identifier, and stores the new identifier with which the history reserve information is associated, as the history records to the history storage device.

5. The identifier switching device according to claim 1,
wherein the processing circuitry sets the rule information, and stores the rule information being set, to the rule information storage device.

6. The identifier switching device according to claim 1,
wherein the rule information has a plurality of subrules, and
wherein the processing circuitry, when referring to the rule information, collates the identifier with each subrule of the plurality of subrules.

7. A non-transitory computer readable medium storing an identifier switching program that causes a computer to execute:
a switching request process of outputting a switching request that requests switching to a new identification; and
a determination process of referring to rule information in a rule information storage device which stores the rule information and history information in a history storage device which stores the history information, when the switching request is outputted, the rule information being information for determining the new identifier and in which a history condition that is a use history of the new identifier is defined as a condition for determining the new identifier, the history information having a plurality of history records in each of which an identifier and a use history of the identifier are associated; and determining, from among the plurality of history records, an identifier that agrees with the rule information, as the new identifier.

8. An identifier switching method of:
outputting a switching request that requests switching to a new identification; and
referring to rule information in a rule information storage device which stores the rule information and history information in a history storage device which stores the history information, when the switching request is outputted, the rule information being information for determining the new identifier and in which a history condition that is a use history of the new identifier is defined as a condition for determining the new identifier, the history information having a plurality of history records in each of which an identifier and a use history of the identifier are associated; and determining, from among the plurality of history records, an identifier that agrees with the rule information, as the new identifier.
